(19) United States
(12) Patent Application Publication
(10) Pub. No.: US 2010/0134434 A1
(43) Pub. Date: Jun. 3, 2010

(54) COMMUNICATION DEVICE AND ELECTRICITY SAVING METHOD THEREOF

(75) Inventor: Chia-Wei TU, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: INVENTEC CORPORATION, Taipei (TW)

(21) Appl. No.: 12/626,724

(22) Filed: Nov. 27, 2009

(30) Foreign Application Priority Data
Nov. 28, 2008 (TW) 97146387

(51) Int. Cl. G06F 3/041

(52) U.S. Cl. 345/173

(57) ABSTRACT

An electricity saving method of a communication device is provided. The method is applied to a communication device having a functional unit group. The functional unit group is consisted of a communication module and several functional modules. The electricity saving method includes the following steps. A call is received or given by the communication module. Whether the time of not pressing several keys and a touch screen of the communication device reaches a threshold time is determined. If yes, an unattended mode is activated to disable the functional modules.

This application claims the benefit of Taiwan application Serial No. 97146387, filed Nov. 28, 2008, the subject matter of which is incorporated herein by reference.

### BACKGROUND OF THE INVENTION

1. Field of the Invention

The invention relates in general to a communication device and an electricity saving method thereof, and more particularly to a communication device and an electricity saving method thereof capable of saving electricity when a call is received or given.

2. Description of the Related Art

Along with the advance in science and technology, communication device such as cellular phone has become more and more popular. Thus, the manufacturers are now in an attempt to integrating various modules such as backlight module, image capturing module and multimedia play module in a communication device to satisfy consumers' diversified needs. Meanwhile, battery duration is an important factor in the selection of a communication device to consumers.

The communication devices currently available in the market normally turn off the backlight module to save electricity when receiving or giving a call. Despite the user only needs to activate the communication module to answer or make the call, the communication device will still waste electricity on the operation of other modules. However, considerable electricity will be wasted and make the battery duration of the communication device largely reduced.

### SUMMARY OF THE INVENTION

The invention is directed to a communication device and an electricity saving method thereof. When a call is received or given, an unattended mode is activated to disable several functional modules if it is determined that the time of not pressing the keys and the touch screen reaches a predetermined threshold time. Thus, electricity will not be wasted in the functional modules when the call is received or given, hence saving electricity.

According to a first aspect of the present invention, an electricity saving method of a communication device is provided. The method is applied to a communication device having a functional unit group. The functional unit group is consisted of a communication module and several functional modules. The electricity saving method includes the following steps. Firstly, a call is received or given by the communication module. Next, whether the time of not pressing several keys and a touch screen of the communication device reaches a threshold time is determined. If yes, an unattended mode is activated to disable the functional modules.

According to a second aspect of the present invention, a communication device with electricity saving function is provided. The communication device includes a touch screen, several keys, a functional unit group, a detecting unit and a processing unit. The functional unit group is consisted of a communication module and several functional modules. The communication module is used for receiving or giving a call. The detecting unit includes a detection module and a timer module. The detection module is used for determining whether the touch screen and the keys are pressed when the call is received or given. The timer module is used for calculating an idle time of not pressing the touch screen and the keys when the call is received or given. The detection module is further used for determining whether the idle time reaches a threshold time. When the detection module determines that the idle time reaches the threshold time when the call is received or given, the processing unit activates an unattended mode to disable the functional modules.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of a communication device with electricity saving function according to a preferred embodiment of the invention;

FIG. 2 shows an example of a time sequence diagram of the operating modes, the keys and the call of the communication device of FIG. 1;

FIG. 3 shows an example of a flowchart of an electricity saving method according to a preferred embodiment of the invention.

### DETAILED DESCRIPTION OF THE INVENTION

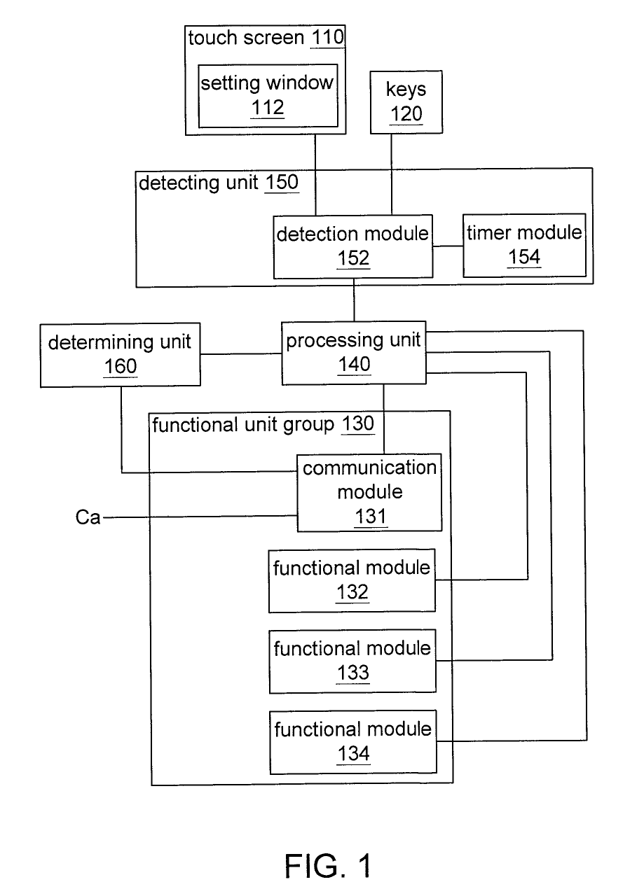

Referring to FIG. 1, a block diagram of a communication device with electricity saving function according to a preferred embodiment of the invention is shown. The communication device 100 such as a cellular phone for example includes a touch screen 110, several keys 120, a functional unit group 130, a processing unit 140 and a detecting unit 150. The functional unit group 130 is consisted of a communication module 131 and several functional modules 132˜134. The communication module 131 is for receiving or giving a call Ca. The functional modules 132˜134 are a backlight module, an image capturing module and a multimedia play module for example. The processing unit 140 is respectively coupled to the communication module 131 and the functional modules 132˜134.

The detecting unit 150 includes a detection module 152 and a timer module 154. The detection module 152 is for determining whether the touch screen 110 and the keys 120 are pressed when the call Ca is received or given. The timer module 154 is for calculating an idle time of not pressing the touch screen 110 and the keys 120 when the call Ca is received or given. Beside, the detection module 152 further determines whether the idle time reaches a threshold time such as 10 seconds for example.

If the detection module 152 determines that the idle time reaches the threshold time when the call Ca is received or given, the user does not need to use the functional modules 132˜134 for the time being. Thus, the processing unit 110 activates the unattended mode to disable functional modules 132˜134, hence avoiding electricity being wasted on the functional modules 132˜134 not used by the user and saving electricity.

Despite the functional unit group 130 is exemplified by three functional modules 132˜134 in the present embodiment of the invention, such exemplification is not for limiting the invention. In other embodiments, the functional unit group 130 can have two functional modules, four or more than four functional modules.

Preferably, the detection module 152 continually detects whether the idle time reaches the threshold time when the call Ca is received or given so as to assure that the processing unit 140 will activate the unattended mode to effectively save electricity each time when the idle time reaches the threshold time. The detection module 152 continually read the idle time from the timer module 154 by way of polling so as to determine whether the idle time reaches the threshold time.

Furthermore, after the processing unit 140 activates the unattended mode, the user may need to use the functional modules 132˜134. Thus, the detection module 152 further determines whether the keys 120 are pressed in the unattended mode. If the detection module 152 determines that the keys 120 are pressed in the unattended mode, the processing unit 140 activates a power-on mode to enable functional modules 132˜134. Thus, when the communication device 100 is in the unattended mode, the user can press the keys 120 to activate the power-on mode to use the functional modules 132˜134 such as the backlight module.

Also, when the processing unit 140 activates the power-on mode and the communication module 131 is receiving or giving the call Ca, the timer module 154 again calculates the idle time of the touch screen 110 and the keys 120, and the detection module 152 again determines whether the idle time reaches the threshold time. Thus, if the idle time reaches the threshold time again after the user finishes operating the functional modules 132˜134, the processing unit 140 activates the unattended mode again to disable functional modules 132˜134 and effectively save electricity.

In the present embodiment of the invention, the communication device 100 further includes a determining unit 160 for determining whether the call Ca is over in the unattended mode. If the determining unit 160 determines that the call Ca is over in the unattended mode, the processing unit 140 activates the power-on mode to enable the functional modules 132˜134.

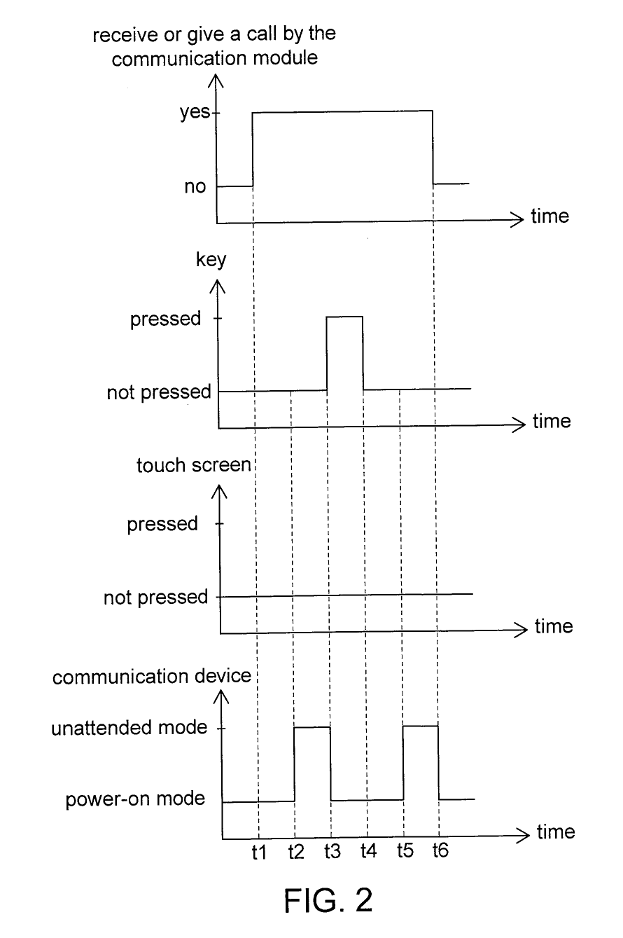

Referring to FIG. 2, an example of a time sequence diagram of the operating modes, the keys and the call of the communication device of FIG. 1 is shown. The communication module 131 receives or gives a call Ca at time point t1. The timer module 154 starts to calculate the idle time of not pressing the keys 120 and the touch screen 110 from time point t1. If the detection module 152 determines that the idle time reaches a threshold time (that is, t2−t1≧the threshold time) at time point t2, then the processing unit 140 activates the unattended mode at time point t2.

Moreover, if the detection module 152 determines that the keys 120 are pressed at time point t3, then the processing unit 140 activates the power-on mode at time point t3. If the keys 120 are no more pressed from time point t4, then the timer module 154 again calculate the idle time of not pressing the keys 120 form time point t4 and the detection module 152 determines that the idle time reaches the threshold time (that is, t5−t4≧the threshold time) at time point t5, then the processing unit 140 again activates the unattended mode at time point t5. Next, if the determining unit 160 determines that the call Ca is over at time point t6, then the processing unit 140 activates the power-on mode at time point t6.

Preferably, as indicated in FIG. 1, the touch screen 110 is further used for displaying a setting window 112 for the user to set the threshold time. Thus, the user can set the threshold time in the setting window 112 according to the experience of use.

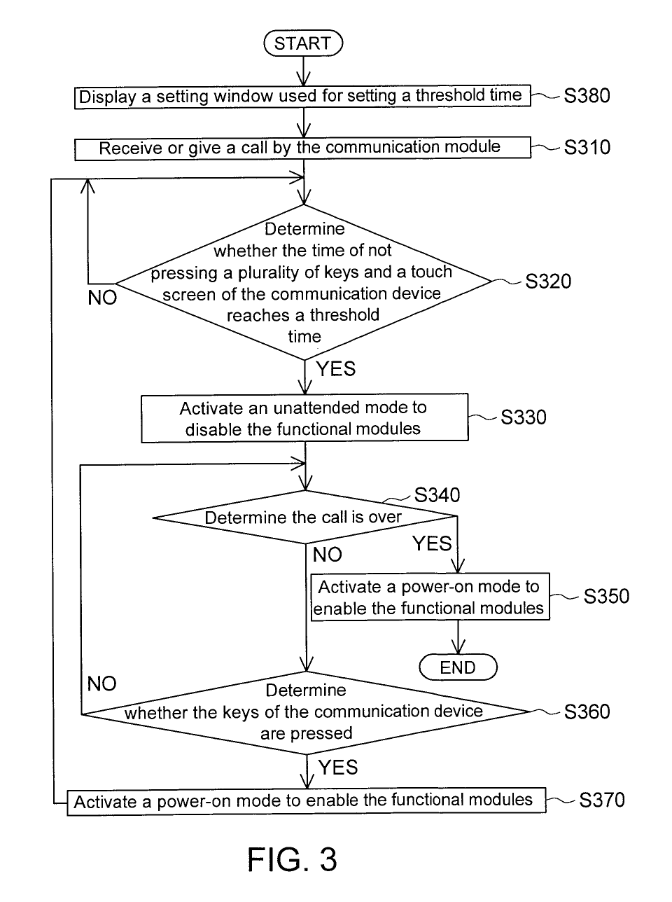

Referring to FIG. 3, an example of a flowchart of an electricity saving method according to a preferred embodiment of the invention is shown. Firstly, the method begins at step S300, a setting window 112 for setting the threshold time is displayed on a touch screen 110 for the user to set the threshold time.

Next, the method proceeds to step S310, a call Ca is received or given by a communication module 131. Then, the method proceeds to step S320, whether the time (that is, the idle time) of not pressing several keys 120 and the touch screen 110 reaches a threshold time is determined by a detection module 152. The detection module 152 continually read the idle time from a timer module 154 by way of polling to determine whether the idle time reaches the threshold time.

If the detection module 152 determines that the time of not pressing the keys 120 and the touch screen 110 reaches the threshold time, then step S330 is executed. If the detection module 152 determines that the time of not pressing the keys 120 and the touch screen 110 does not reach the threshold time, then step S320 is repeated.

In step S330, the processing unit 140 activates the unattended mode to disable the functional modules 132˜134 such as a backlight module, an image capturing module and a multimedia play module image. Thus, electricity is saved by disabling the functional modules 132˜134 if the time of not pressing the keys 120 and the touch screen 110 reaches the threshold time when the call Ca is received or given.

Afterwards, the method proceeds to step S340, whether the call Ca is over is determined by the determining unit 160 in the unattended mode. If the determining unit 160 determines that the call Ca is over, then step S350 is executed. If the determining unit 160 determines that the call Ca is not over, then step S360 is executed.

In step S350, the processing unit 140 activates the power-on mode to enable the functional modules 132˜134. In step S360, whether the keys 120 are pressed is determined by the detection module 152. If the detection module 152 determines that the keys 120 are pressed, then step S370 is executed. If the detection module 152 determines that the keys 120 are not pressed, then step S340 is repeated. In step S370, the processing unit 140 activates the power-on mode to enable the functional modules 132˜134.

According to the communication device and the electricity saving method thereof disclosed in the above embodiments of the invention, the unattended mode is activated to disable the functional modules such as a backlight module, an image capturing module or a multimedia play module if the time of not pressing the keys and the touch screen reaches a predetermined threshold time when a call is received or given. Thus, electricity will not be wasted on functional modules when a call is received or given, and electricity is saved. Also, in the unattended mode, the user can press the keys to activate the power-on mode by the processing unit, so that the functional modules can be used. Moreover, if the idle time of not pressing the keys and the touch screen once again reaches the threshold time in the power-on mode, the user can activates the unattended mode by the processing unit to disable the functional modules and effectively save electricity.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electricity saving method of a communication device, wherein the electricity saving method is applied to a communication device having a functional unit group consisted of a communication module and a plurality of functional modules, the electricity saving method comprises:
a. receiving or giving a call by the communication module;
b. determining whether the time of not pressing a plurality of keys and a touch screen of the communication device reaches a threshold time: if yes, step c is executed; and
c. activating an unattended mode to disable the functional modules.

2. The electricity saving method according to claim 1, wherein the step b is repeated if it is determined that the time of not pressing the keys and the touch screen of the communication device does not reach the threshold time.

3. The electricity saving method according to claim 1, wherein after the step c, the method further comprises:
d. determining whether the keys of the communication device are pressed in the unattended mode: if yes, step e is executed; and
e. activating a power-on mode to enable the functional modules.

4. The electricity saving method according to claim 3, wherein after the step e, the step b is repeated.

5. The electricity saving method according to claim 1, wherein after the step c, the method further comprises:
f. determining whether the call is over in the unattended mode: if yes, step g is executed;
g. activating a power-on mode to enable the functional modules.

6. The electricity saving method according to claim 1, further comprising:
displaying a setting window used for setting the threshold time.

7. The electricity saving method according to claim 1, wherein the threshold time is 10 seconds.

8. The electricity saving method according to claim 1, wherein the functional modules comprises a backlight module, an image capturing module and a multimedia play module.

9. A communication device with electricity saving function, comprising:
a touch screen and a plurality of keys;
a functional unit group consisted of a communication module and a plurality of functional modules, wherein the communication module is used for receiving or giving a call;
a detecting unit, comprises:
a detection module used for determining whether the touch screen and the keys are pressed when the call is received or given; and
a timer module used for calculating an idle time of not pressing the touch screen and the keys when the call is received or given, and the detection module is further used for determining whether the idle time reaches a threshold time; and
a processing unit used for activating an unattended mode to disable the functional modules if the detection module determines that the idle time reaches the threshold time when the call is received or given.

10. The communication device with electricity saving function according to claim 9, wherein the detection module continually determines whether the idle time reaches the threshold time when the call is received or given.

11. The communication device with electricity saving function according to claim 9, wherein the detection module further determines whether the keys are pressed in the unattended mode;
wherein the processing unit further activates a power-on mode to enable the functional modules when the detection module detects that the keys are pressed in the unattended mode.

12. The communication device with electricity saving function according to claim 11, wherein after the processing unit activates the power-on mode, the timer module again calculates the idle time of not pressing the touch screen and the keys, and the detection module again determines whether the idle time reaches the threshold time.

13. The communication device with electricity saving function according to claim 9, further comprising:
a determining unit used for determining whether the call is over in the unattended mode;
wherein the processing unit activates a power-on mode to enable the functional modules when the determining unit determines that the call is over in the unattended mode.

14. The communication device with electricity saving function according to claim 9, wherein the touch screen is further used for displaying a setting window used for setting the threshold time.

15. The communication device with electricity saving function according to claim 9, wherein the threshold time is 10 seconds.

16. The communication device with electricity saving function according to claim 9, wherein the functional modules comprises a backlight module, an image capturing module and a multimedia play module.
